(19) United States
(12) Patent Application Publication
(10) Pub. No.: US 2018/0263182 A1
(43) Pub. Date: Sep. 20, 2018

(54) USER IDENTIFICATION AND CUSTOMIZATION FOR OUTDOOR POWER MACHINES

(71) Applicant: Husqvarna AB, Huskvarna (SE)

(72) Inventors: Matthew Albinger, Shelby, NC (US); Duncan Burns, Jr., Charlotte, NC (US); Eric C. Canonge, Charlotte, NC (US); Jonathan Funk, Concord, NC (US); Eric Tse, Charlotte, NC (US)

(21) Appl. No.: 15/540,178

(22) PCT Filed: Dec. 3, 2015
(86) PCT No.: PCT/IB2015/059336

§ 371 Date: Jun. 27, 2017

Related U.S. Application Data
(60) Provisional application No. 62/097,187, filed on Dec. 29, 2014.

(51) Int. Cl. A01D 34/00; G06F 21/36; G05D 1/02

(52) U.S. Cl. CPC A01D 34/008; A01D 2101/00; G05D 1/0278; G06F 21/36

(57) ABSTRACT

An outdoor power machine apparatus includes a prime mover, such as a combustion engine or an electric motor. The outdoor power machine is operable to carry out machine function, e.g. a material handling function. An electronic controller is connected to a machine function and identifies a specific user and controls the machine function based on the identity of the user. The controller may be configured to permit or deny operation of the machine function based on the user's identity. The controller may be configured to operate the machine function in a desired manner based on the user's identity.

### BACKGROUND OF THE INVENTION

This invention relates generally to outdoor power machines and more particularly to customized control of outdoor power machines based on the user's identity.

Numerous types of outdoor power machines are known, defined generally as any machine having a prime mover driving a component, implement, or attachment which is operable for material removal and/or material handling. Nonlimiting examples of outdoor power machines include lawn mowers, snow blowers, chain saws, blowers, and hand-held trimmers.

While outdoor power machines are useful and beneficial, they have the potential to cause injury or property damage, either intentionally by criminals, or unintentionally by inexperienced operators. Furthermore, the machines themselves can be damaged when used by untrained or careless operators. Existing physical security measures such as fences, locks, etc. can prevent unauthorized access but are inconvenient and lack flexibility.

Known outdoor power machines can also include numerous customizable or adjustable functions to make them more comfortable or easier to use. A particular outdoor power machine may have several different users. In prior art machines, each user is required to re-adjust some or all of the customizable or adjustable functions each time he or she uses the machine.

Accordingly, there remains a need for an outdoor power machine having secure, flexible control provisions for its machine functions.

### BRIEF SUMMARY OF THE INVENTION

This need is addressed by the present invention, which provides an outdoor power machine having one or more machine functions that are linked to an electronic controller. The controller includes means for identifying a user of the outdoor power machine, and based on the user's identity, selectively controlling the functions of the outdoor power machine.

According to one aspect of the invention, {this section to be completed upon approval of claims}

According to one aspect of the invention, 1. An outdoor power machine apparatus includes: an outdoor power machine including a prime mover, the outdoor power machine operable to carry out at least one machine function; an electronic controller operably connected to the at least one machine function and configured to identify a specific user and to control the at least one machine function based on the identity of the user.

According to another aspect of the invention, the controller is configured to permit or deny operation of at least one machine function based on the user's identity.

According to another aspect of the invention, the controller is configured to operate at least one machine function in a desired manner based on the user's identity.

According to another aspect of the invention, one of the at least one machine functions is a material handling implement driven by the prime mover, and the controller is operable to permit or deny operation of the material handling implement based on the user's identity.

According to another aspect of the invention, one of the at least one machine functions is an adjustable machine component moveable between different positions, and the controller is operable to move the adjustable component to a specified position based on the user's identity.

According to another aspect of the invention, the controller is configured to identify a user in response to a code provided by the user.

According to another aspect of the invention, the controller is configured to identify a user in response to a data transmission from a user device.

According to another aspect of the invention, the controller is configured to identify a user in response to a predefined combination of two or more identification methods.

According to another aspect of the invention, the controller includes a positioning device operable to determine a location of the outdoor power machine.

According to another aspect of the invention, the controller includes a data communications channel operable for two-way communication with an external data source.

According to another aspect of the invention, the controller includes a user communications channel operable for two-way communication with a user device.

According to another aspect of the invention, the controller includes stored data relating each unique user to a set of privileges and preferences with respect to machine functions.

According to another aspect of the invention, the controller includes a physical user interface including at least one display element and at least one input control.

According to another aspect of the invention, an outdoor power machine control system includes: an outdoor power machine including a prime mover, the outdoor power machine operable to carry out at least one machine function; an electronic controller operably connected to the at least one machine function and operable to identify a specific user and control the at least one machine function based on the identity of the user; a user device having a processor and presenting a remote user interface to the controller; and a user communications channel providing data communications between the controller and the user device.

According to another aspect of the invention, the remote user interface comprises a software application.

According to another aspect of the invention, the controller includes a physical user interface including at least one display element and at least one input control; and the remote user interface is a reproduction of at least part of the physical user interface.

According to another aspect of the invention, the remote user interface is operable to send override commands to the controller.

According to another aspect of the invention, the controller is configured to identify a user in response to a code provided by the user through the remote interface.

According to another aspect of the invention, the controller is configured to identify a user in response to a data transmission from the user device.

According to another aspect of the invention, the controller is configured to identify a user in response to a predefined combination of two or more identification methods.

According to another aspect of the invention, the controller includes a data communications channel operable for two-way communication with an external data source separate from the user device.

According to another aspect of the invention, the controller includes stored data relating each unique user to a set of privileges and preferences with respect to machine functions, and the remote interface is operable to edit the stored data.

According to another aspect of the invention, a method of operating an outdoor power machine includes: operably connecting an electronic controller to at least one machine function of an outdoor power machine that includes a prime mover; using the controller to identify a specific user; and controlling the at least one machine function based on the identity of the user.

According to another aspect of the invention, the controller identifies a user by a unique code provided by the user.

According to another aspect of the invention, the controller identifies a user in response to a data transmission from a user device.

According to another aspect of the invention, the controller identifies a user in response to a predefined combination of two or more identification methods.

According to another aspect of the invention, the controller is configured to permit or deny operation of at least one machine function based on the user's identity.

According to another aspect of the invention, the controller is configured to operate at least one machine function in a desired manner based on the user's identity.

According to another aspect of the invention, one of the at least one machine functions is a material handling implement driven by the prime mover, and the controller is programmed to permit or deny operation of the material handling implement based on the user's identity.

According to another aspect of the invention, one of the at least one machine functions is an adjustable machine component moveable between different positions, and the controller is programmed to move the adjustable component to a specified position based on the user's identity.

According to another aspect of the invention, the controller includes stored data relating each unique user to a set of privileges and preferences with respect to machine functions.

### BRIEF DESCRIPTION OF THE DRAWINGS

The invention may be best understood by reference to the following description taken in conjunction with the accompanying drawing figures, in which:

FIG. 1 is a schematic perspective view of a walk-behind lawn mower;

FIG. 2 is a schematic side view of a riding lawn mower;

FIG. 3 is diagram of a system including an outdoor power machine and a user;

FIG. 4 is a schematic of a controller;

FIG. 5 is a front view of a user interface;

FIG. 6 is a front view of a remote user interface showing a first menu page; and

FIG. 7 is a front view of a remote user interface showing a second menu page.

### DETAILED DESCRIPTION OF THE INVENTION

Generally, the present invention includes an outdoor power machine having one or more machine functions that are linked to an electronic controller. The controller includes means for identifying a user of the outdoor power machine, and based on the user's identity, selectively controlling the functions of the outdoor power machine.

As used herein, the term “machine function” or “outdoor power machine function” refers to any action or operation that the outdoor power machine is capable of carrying out, and includes inherent machine operations such as transportation, cutting, etc. as well as ancillary functions such as adjustments, operator comfort features, etc. and operations of any accessories attached to the outdoor power machine.

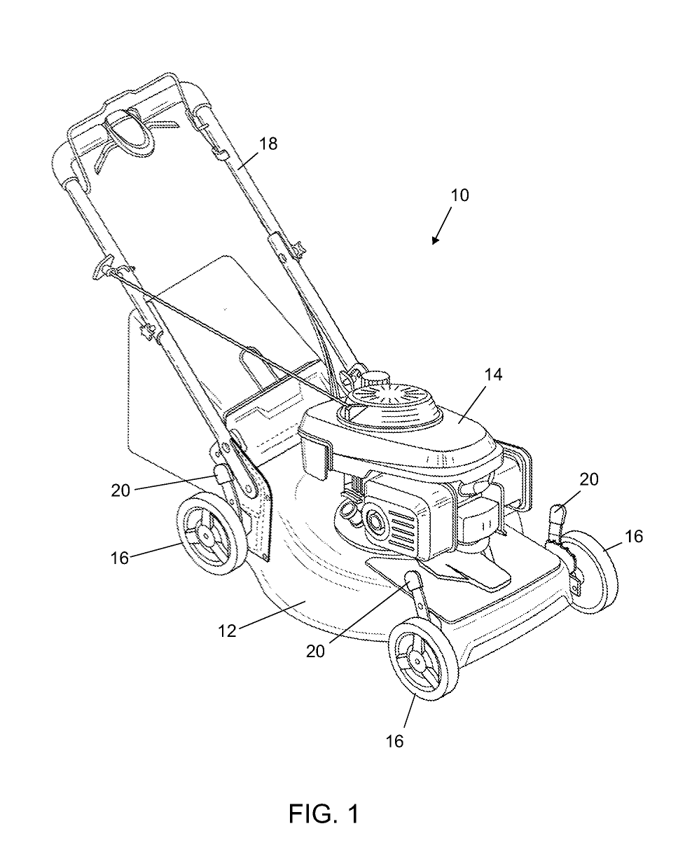

Now, referring to the drawings wherein identical reference numerals denote the same elements throughout the various views, FIG. 1 illustrates a walk-behind lawn mower 10 which is an example of an outdoor power machine that may implement the controller and method of the present invention. The lawn mower 10 includes a blade housing or deck 12 that houses a rotatable cutting blade (not shown) that is turned by a prime mover 14 of a known type, such as the illustrated internal combustion engine or an electric motor (not shown). The prime mover 14 may be provided with a self-starter of a known type (not shown), or in the case of an electric motor, appropriate switching equipment (not shown). Wheels 16 are mounted to the deck 12 and permit the lawn mower 10 to be pushed by a user via a handle 18 mounted to the deck 12. Alternatively, a transmission may be used to drive the wheels 16 using power from the prime mover 14. The height of the wheels 16 may be adjustable, for example using mechanical adjusters 20, in order to provide a level cut and/or to adjust the height of the cutting blade.

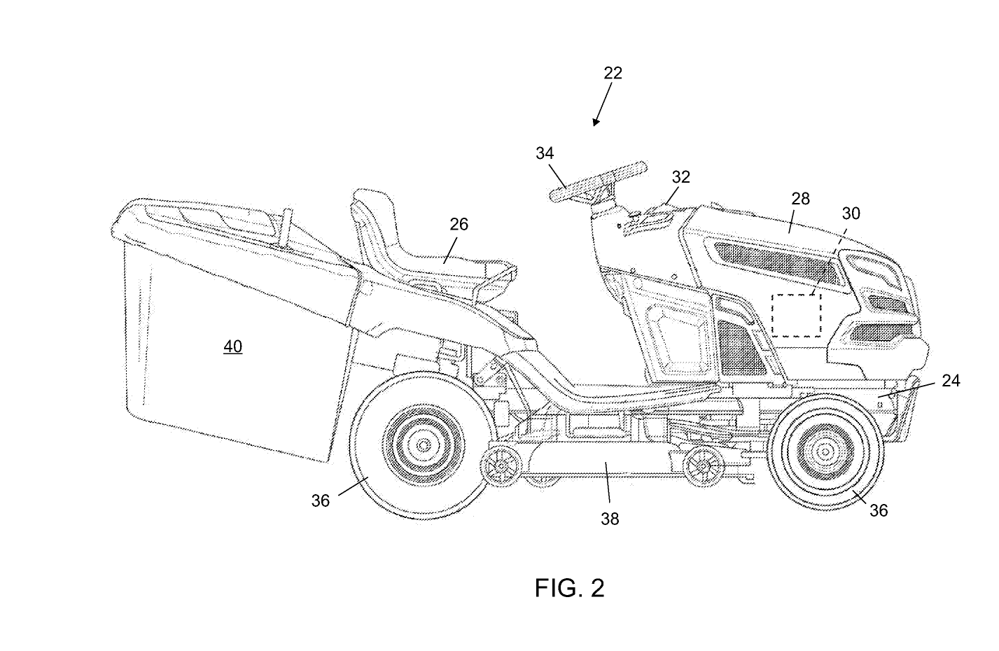

FIG. 2 illustrates a riding lawn mower 22 which is another example of an outdoor power machine that may implement the controller and method of the present invention. A chassis 24 provides basic structural support for the riding mower 22. Mounted to the chassis 24 are an operator seat 26, a hood 28 enclosing a prime mover 30 of a known type (such as an internal combustion engine or an electric motor), a control panel 32, and a steering control 34 (e.g., a steering wheel, handle bars, or other steering apparatus). The chassis 24 rolls on wheels 36. Some or all of the wheels 36 are driven by the prime mover 30 using a transmission, and some or all of the wheels 36 are steerable to control the direction of travel of the riding mower 22, in response to inputs from the steering control 34.

A cutting deck 38 is suspended under the chassis 24 and its height may be adjustable. The cutting deck 38 encloses one or more cutting blades (not shown) which are driven by the prime mover 30. For example, the blades could be coupled to the prime mover via mechanical elements such as belts and pulleys, gears, and/or shafts. Alternatively, the blades may be driven directly by an electric motor (not shown). When mowing, the grass clippings may be captured by a collection system such as the illustrated bagging attachment 40, mulched, or expelled from the cutting deck 38 via a discharge chute.

The lawn mowers 10 and 22 described above are merely two examples of known types of outdoor power machines. The principles of the present invention are applicable to any outdoor power machine which has at least one machine function capable of being controlled, directly or indirectly, by an electronic processor-based controller. Nonlimiting examples of outdoor power machines include a riding lawn mower (e.g., a lawn tractor, front-mount riding lawn mower, zero-turn-radius riding lawn mower, cross mower, stand-on riding lawn mower, robotic mowers, walk-behind lawn mowers, remote-controlled lawn mowers, snow blowers, chain saws, blowers, and hand-held trimmers).

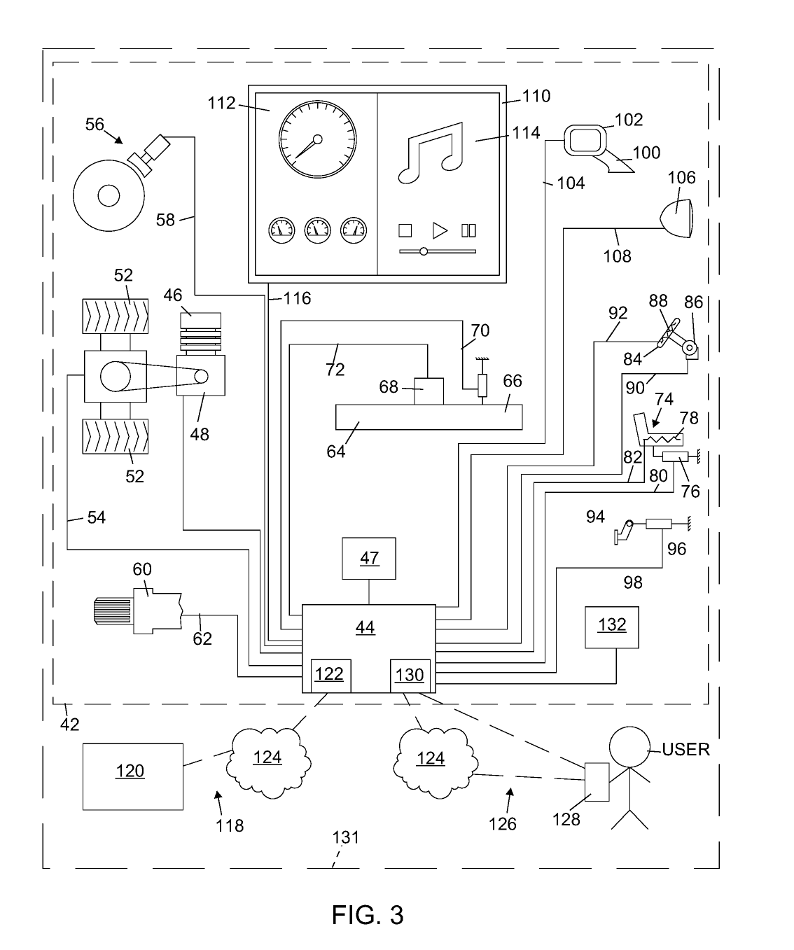

FIG. 3 illustrates schematically a generic outdoor power machine 42 used to illustrate the apparatus and method of the present invention. Generally, the outdoor power machine 42 includes one or more functional units, described in more detail below, which are operably connected to a controller 44, which is described in more detail below. In FIG. 3, connections for the transmission of data, power, and/or control between the controller 44 and the functional units are shown in single-line format. It will be understood that these connections can be direct or indirect, wired or wireless, or function.

The outdoor power machine 42 includes a prime mover 46 such as an electric motor or internal combustion engine. The controller 44 is connected to the prime mover 46 by a line 48 and is configured to control functions of the prime mover 46 such as starting, stopping, and prime mover speed. The outdoor power machine 42 may include a conventional storage battery 47 used to power the functional units of the outdoor power machine 42 as well as the controller 44.

The outdoor power machine 42 includes a transmission 50 coupled to the prime mover 46 and to final drive elements of the outdoor power machine 42 (in this case, rear wheels 52).The controller 44 is connected to the transmission 50 by a line 54 and is configured to control functions of the transmission 50 such as gear range selection (i.e. reverse-neutral-drive), ground speed, and braking functions.

The outdoor power machine 42 may include a parking brake 56 operable to selectively apply braking force to the wheels 52.The controller 44 is connected to the parking brake 56 by a line 58 and may be configured to detect the parking brake status and/or to control on/off application of the parking brake 56.

The outdoor power machine 42 may include a power take-off (“PTO”) 60 such as a shaft or pulley coupled to the prime mover 46 and operable to provide mechanical power to an accessory (not shown). The controller 44 is connected to the PTO 60 by a line 62 and is configured to control functions of the PTO 60 such as shaft start/stop and shaft speed.

The outdoor power machine 42 may include a mowing deck 64 which is coupled to a deck actuator 66 (or actuators) operable to change aspects of height of the mowing deck 64, such as its height, pitch angle, or leveling aspect. It is also possible to use one or more actuators to change the operating mode of the mowing deck 64 (e.g. external discharge, mulching, or bagging). The mowing deck 64 may further include a blade actuator 68, such as an electric blade drive motor or an electrically-actuated clutch. The controller 44 is connected to the deck actuator 66 and the blade actuator 68 by lines 70 and 72, respectively. The mowing deck 64 may be considered as an example of a material handling implement, that is, a component, accessory, or attachment operable to modify or move material, such as by cutting, blowing, grinding, pushing, lifting, etc.

The outdoor power machine 42 may include an operator seat 74 which is coupled to a seat actuator 76 operable to change the configuration of the seat 74, such as its height, fore-aft position, lumbar adjustment, etc. The seat 74 may further include an electrically-powered seat temperature control device 78 (i.e. seat heater and/or chiller). The controller 44 is connected to the seat actuator 76 and the seat heater 78 by lines 80 and 82, respectively. The operator seat 74 may be considered as an example of an adjustable machine component, that is, a component which is moveable to two or more different positions or over a range of positions to accommodate different users or different user preferences.

The outdoor power machine 42 may include a hand control 84 such as a steering wheel, which is coupled to a hand control actuator 86 operable to change the position of the hand control 84 (for example it may include tilt or telescoping adjustments). The hand control 84 may further include an electrically-powered control heater 88. The controller 44 is connected to the hand control actuator 86 and the control heater 88 by lines 90 and 92, respectively.

The outdoor power machine 42 may include a foot control 94 such as a brake, clutch, deck height, or transmission control pedal which is coupled to a foot control actuator 96 operable to change the position of the foot control 94. The controller 44 is connected to the foot control actuator 96 by a line 98.

The outdoor power machine 42 may include a mirror 100 which is coupled to a mirror actuator 102 operable to change the orientation and/or position of the mirror 100. The controller 44 is connected to the mirror actuator 102 by a line 104.

The outdoor power machine 42 may include one or more lights 106, such as headlights, taillights, task lights, turn signals, etc. The controller 44 is connected to the light 106 by a line 108 and is operable to turn the light 106 on or off, or alter its position (e.g. height, angle of elevation, or azimuth).

The outdoor power machine 42 may include an operator display 110 which is mounted to the outdoor power machine 42 in a position visible to the operator. The operator display 110 may be a multi-function display (“MFD”) which can be reconfigured to display various elements of information. In the illustrated example, the operator display 110 may be based on light-emitting diode (“LED”) or liquid-crystal display (“LCD”) technology, or other suitable display type and is shown displaying simulated engine gauges 112 on one half and a digital music player control panel 114 on the other half. The controller 44 is connected to the operator display 110 by a line 116.

The controller 44 includes a data communications channel 118 operable for two-way communication with a data source such as an external computer server 120. The data communications channel 118 may comprise an appropriate connection, such as a wireless transceiver 122, to a wide-area network such as the Internet 124.

The controller 44 includes a user communications channel 126 operable for two-way communication with a user device 128, such as a key fob, a remote control, or a general-purpose programmable computer, herein referred to as a personal electronic device (“PED”), e.g., a “smart phone” or tablet-type computer. The user communication channel 126 may include one or more transceivers 130 operating over a short-range channel such as inductive coupling, radio frequency (“RF”), infrared (“IR”), short-range ultra-high frequency (“UHF”) such as BLUETOOTH, a local area network such as Wi-Fi, or a wide-area network such as the Internet 124.

The controller 44 may incorporate or be connected to a positioning device 132 which is operable to determine a location of the outdoor power machine 42, e.g., a global positioning system (“GPS”) receiver, a cellular-network-based positioning device, a Wi-Fi range based device, wheel travel measurements, or an inertial navigation system (“INS”).

Collectively, the outdoor power machine 42 along with the user device 128 may be referred to as a system (indicated at 131) for controlling the outdoor power machine 42.

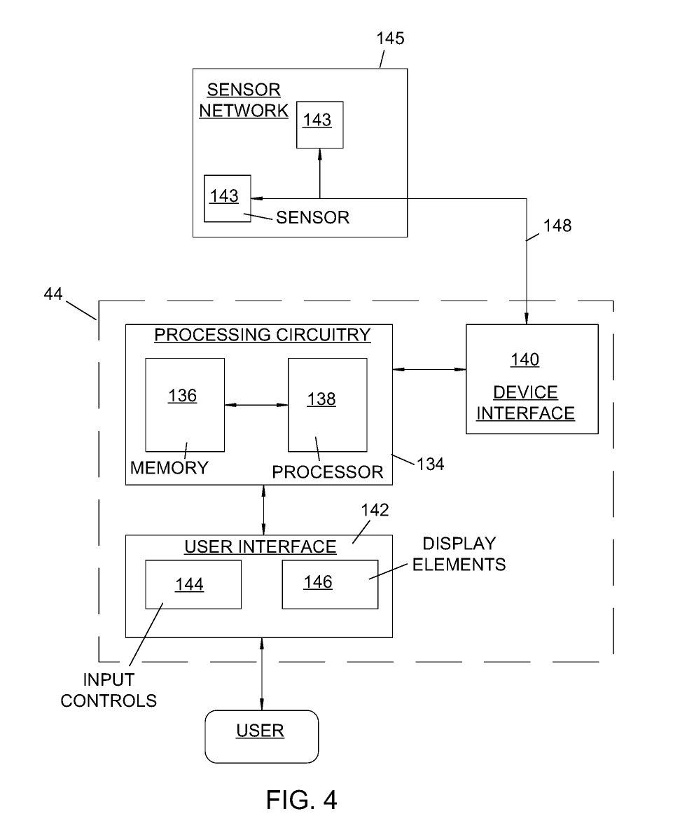

FIG. 4 illustrates a functional block diagram of one possible arrangement of the controller 44. The controller 44 may include processing circuitry 134 to provide electronic control inputs to one or more functional units of the outdoor power machine 42 and to process data generated by the one or more functional units regarding various operational parameters relating to the outdoor power machine 42. The processing circuitry 134 may be configured to perform data processing, control function execution and/or other processing and management services. The processing circuitry 134 may be embodied as a chip or chip set. In other words, the processing circuitry 134 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 134 may therefore, in some cases, be configured as a single chip or as a single “system on a chip.” As such, in some cases, a chip or chipset may constitute means for performing one or more operations for providing the functionalities described herein.

The processing circuitry 134 may include one or more instances of a processor 136 and memory 138 that may be in communication with or otherwise control a device interface 140 and a user interface 142. As such, the processing circuitry 134 may be embodied as a circuit chip (e.g., an integrated circuit chip) configured (e.g., with hardware, software or a combination of hardware and software) to perform operations described herein. However, in some embodiments, the processing circuitry 134 may be embodied as a portion of an on-board computer.

Optionally, the processing circuitry 134 may communicate with electronic components and/or sensors 143 of a sensor network 145 (e.g., sensors that measure variable values related outdoor power machine parameters) via a single data bus 148. As such, the data bus 148 may connect to a plurality or all of the sensors 144, switching components and/or other electrically controlled components of the outdoor power machine 42 to the processing circuitry 134. In an example embodiment, the data bus 148 may further provide a mechanism by which the processing circuitry 134 can interface with or control other functional units of the outdoor power machine 42. For example, in some embodiments, the data bus 148 may provide control inputs to and/or receive status inputs from functional units.

The user interface 142 is operable to receive a user input at the user interface 142 and/or to provide an audible, visual, mechanical or other output to the user. The user interface 142 may include input controls such as one or more levers, switches, buttons or keys (e.g., function buttons), indicated schematically at 144, and may include one or more display elements such as lights, gauges, or display screens, indicated schematically at 146. Other input/output mechanisms are also known, such as touch-screen displays which serve both input and output functions.

The display elements 146 may be used to indicate corresponding status information. The information indicated by the display elements 146 may be directly related to the corresponding input controls 144 in some cases. However, in other cases, some of the display elements 146 may indicate status information associated with other functional units. Meanwhile, the input controls 144 may be employed for initiation of various control operations to actuate or turn off corresponding ones of the functional units.

However, in an example embodiment, the input controls 144 may also have an alternative functionality associated with starting of the prime mover 46. In this regard, for example, the input controls 144 may be used for the provision of a code that is required to start the prime mover 46. In an example embodiment, the input controls 144 may include one button that functions as a start button that must be depressed or otherwise actuated in order to start the prime mover 46. However, the start button may not be enabled for operation to start the prime mover until an unlocking code is entered via other ones of the input controls 144. Thus, the input controls 144 may include at least some code entry or unlocking buttons and a start button and the start button may only be unlocked for starting responsive to entry of an unlocking code using the code entry or unlocking buttons.

The device interface 140 includes one or more interface mechanisms for enabling communication with other devices (e.g., sensors 144 and/or other accessories or functional units such as motors, engines, servos, switches or other operational control devices for providing control functions). The device interface 140 may be implemented as hardware, or a combination of hardware and software that is configured to receive and/or transmit data from/to sensors in communication with the processing circuitry 134 via the data bus 148 or by independent connections. For example, the device interface 140 may include hardware operable to receive low-voltage, low-current digital control signals from the processing circuitry 134 and output higher-voltage, higher-current signals necessary to operate relays, actuators, and the like.

The processor 136 may be embodied in a number of different ways. For example, the processor 136 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 136 may be configured to execute instructions stored in the memory 114 or otherwise accessible to the processor 136. As such, whether configured by hardware or by a combination of hardware and software, the processor 136 may represent an entity (e.g., physically embodied in circuitry—in the form of processing circuitry 110) capable of performing operations according to embodiments of the present invention while configured accordingly. Thus, for example, when the processor 136 is embodied as an ASIC, FPGA or the like, the processor 136 may be specifically configured hardware for conducting the operations described herein. Alternatively, as another example, when the processor 136 is embodied as an executor of software instructions, the instructions may specifically configure the processor 136 to perform the operations described herein.

The processor 136 (or the processing circuitry 134) may be embodied as, include or otherwise control the operation of the outdoor power machine 42 based on inputs received by the processing circuitry 134 responsive to inputs from the input controls 144 and/or the operation of various ones of the functional units. As such, in some embodiments, the processor 136 (or the processing circuitry 134) may be said to cause each of the operations described in connection with the outdoor power machine 42 in relation to operation of the functional units and/or input controls 144 to undertake the corresponding functionalities, responsive to execution of instructions or algorithms configuring the processor 136 (or processing circuitry 134) accordingly. The processor 136 may be physically located within a body that houses the electronics for the user interface 142, and the processor 136 may be sole processor for the outdoor power machine 42.

The memory 138 may include one or more nontransitory memory devices such as, for example, volatile and/or non-volatile memory that may be either fixed or removable. The memory 138 may be configured to store information, data, applications, instructions or the like for enabling the processing circuitry 134 to carry out various functions as described herein. For example, the memory 138 could be configured to buffer input data for processing by the processor 138. Additionally or alternatively, the memory 138 could be configured to store instructions for execution by the processor 138. As yet another alternative or additional capability, the memory 138 may include one or more databases that may store a variety of data sets responsive to input from sensors 144, functional units and/or the input controls 132. Among the contents of the memory 138, applications may be stored for execution by the processor 138 in order to carry out the functionality associated with each respective application.

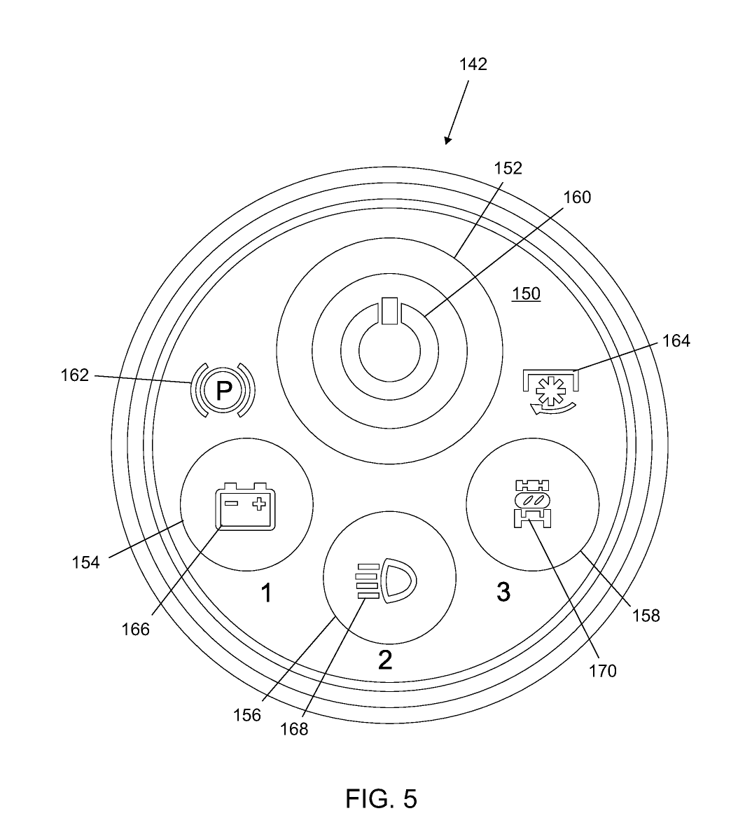

FIG. 5 is an illustration showing one example of how the user interface 142 may be physically configured. Many possible physical configurations are possible. The user interface 142 may include a panel face 150 on which the display elements 146 and the input controls 144 are provided.

The user interface 142 may have multiple modes of operation that impact the functioning of the controller 44 and various other components of the outdoor power machine 42. In an example embodiment, the user interface 142 may have an off or sleep mode, a wake-up mode, a ready to start or starting mode, and a running mode. The wake-up mode and the starting mode may generally be transient modes that are not allowed to be maintained for a long period of time. As such, the wake-up mode and the starting mode may each have time limits associated therewith such that if no activity is noted in each respective mode within a given period of time, the user interface 142 will be returned to one of the non-transient modes of operation (i.e., the sleep mode or the running mode). The sleep mode and the running mode are generally capable of continued and indefinite operation as long as other prerequisites to operation in such modes are met.

In the example shown in FIG. 5, the panel face 150 includes function buttons including a power button 152, a first key 154, a second key 156, and a third key 158, each of which are examples of input controls 144 described above. The function buttons 152, 154, 156, 158 may be any kind of pushbutton, press button or the like, and may be flush-mounted or may extend outward from the panel face 150. Actuation of the function buttons may initiate a changing of a switch position or an indication to the processing circuitry 134 to indicate that a corresponding function button has been actuated. In some cases, the function buttons may be biased switches that return to their original position after each actuation thereof. Thus, a most recent position or current status of the function buttons may be maintained within the processing circuitry 134 and the processing circuitry 134 may also interface with other appropriate devices to actuate the functionality associated with any one of the function buttons that is actuated and/or to turn on any display elements 146 or other display indications that are appropriate to indicate the status of a device impacted by operation of one of the function buttons.

The panel face 150 also includes a first light 160, a second light 162, a third light 164, a fourth light 166, a fifth light 168 and a sixth light 170, which are examples of display elements 146 described above. The lights may each be a single color or may have multiple potential colors. In some cases, the lights may have variable intensity so that brightness may ramp up (or down) over time. In some cases, the ramp up or down function may be based on external conditions. For example, if it is dark, a ramp up may be initiated. Blinking, lighting patterns and/or color changes may indicate specific conditions or operation modes related to respective different ones of the lights, or to the operation of the user interface 142 in general. Audible signals are also possible.

The first light 160 may be associated with the power button 152 and indicates engine status and user interface mode of operation. The second light 162 is a parking brake indicator light that is lit when a parking brake is or is not set, depending on the current mode. The third light 164 is a power take off (“PTO”) engagement indicator light that is lit when the PTO 60 is engaged and off when the PTO 60 is not engaged. The fourth light 166 is a battery light that indicates a status of the battery 47 when lit. For example, the fourth light 166 may be lit whenever battery level is low. The fourth light 166 may be disposed on the first key 154. The fifth light 168 is a headlight indicator light that is lit when the headlights (not shown) are energized and off when they are not energized. The fifth light 168 may be disposed on the second key 156. The sixth light 170 is a mow-in-reverse (“MIR”) indicator light that is lit when MIR is activated and off when MIR is not activated. However, in some embodiments. The sixth light 170 may be disposed on the third key 158.

Because the first, second, and third keys 154, 156, and 158 may have multiple functions (i.e., different functions in different modes) and one such function may be code entry, a code value or number associated with each respective one of the first, second and third keys 154, 156, and 158 may be indicated on or proximate to each key. Thus, for example, if a valid starting code is “1-3-2,” the operator may be enabled to correlate the value “1” with the first key 154, and correlate the value “3” with the third key 158, while correlating the value “2” with the second key 156. The operator may then enter each key actuation in sequence to unlock the functionality of the power button 152 for prime mover startup. In other words, the code entry keys may enter the code for shifting from wake-up mode to starting mode.

The first, second and third keys 154, 156, and 158 may each be multi-function buttons that have different corresponding functions dependent upon the status or mode of operation of the user interface. Moreover, the first, second and third keys 154, 156, and 158 may interface with the processing circuitry 134 to determine the mode of operation of the user interface 142. As an example, in one embodiment the first, second and third keys 154, 156, and 158 may be code entry buttons while the user interface is in a wake-up mode and may actuate specific associated functionalities while the user interface 142 is in the running mode. In some embodiments, as an example, the first, second and third keys 154, 156, and 158 may be code entry keys (but not impact any functional units) in a wake-up mode of the user interface 142. However, in the running mode of the user interface 142, the first key 154 may be used to indicate battery status via the fourth light 166, the second key 156 may operate headlights 106 and may indicate headlight status via the fifth light 168, and the third key 158 may engage/disengage MIR and indicate MIR status via the sixth light 170.

Meanwhile, the power button 152 may also be a multi-function key insofar as the power button 152 may have a different function in each of at least two different operating modes of the user interface. For example, the power button 152 may wake the user interface 142 to initiate the wake-up mode when the user interface 142 is initially off or in a sleep mode. Thereafter, the power button 152 may have no function other than to indicate the wakeup mode (e.g., via the first light 160) in the wake-up mode. However, the power button 152 may be enabled to initiate engine start responsive to operation thereof in the starting mode (and may also indicate the starting mode via the first light 160. The power button 152 may then be enabled to stop engine operation in the running mode.

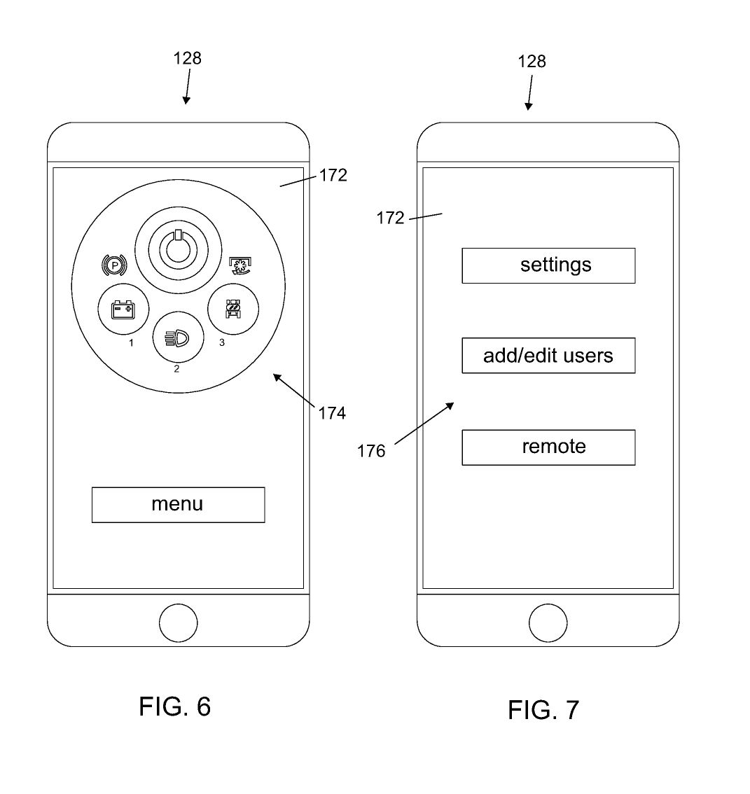

The outdoor power machine 42 may be coupled with a remote user interface. The remote user interface comprises software enabling communication with and remote operation of the controller 44. In the example shown in FIGS. 6 and 7, the remote user interface is embodied as a software application or remote control “app” 172 running on the user device 128, for example a PED as described above. In FIG. 6, the remote control app 172 is shown having a software representation 174 mimicking all or a part of the user interface 142 described above, and in FIG. 7, the remote control app 172 is shown as having an administrative menu 176 permitting programming of the controller 44 and override functions as described in more detail below.

The controller 44 includes a means for positively identifying the user, or stated another way, discriminating one user from another.

Each user may be associated with a unique code. For example, the owner or administrator may be assigned the code “3-1-2”. This code may be directly input to the controller 44 using the keys 154, 156, 158 of the user interface 142 to enter the digits in sequence.

As another example, each user could be provided with a unique code which is transmitted remotely to the controller 44 from the remote user interface via the user communications channel 126. For example, the user would open the remote control app 172 and issue a command to transmit the unique code.

As another example, the user could be identified by transmission of credentials associated with a device in the user's possession, i.e. the user device 128 described above. For example, the user device 128 may be a PED with an associated International Mobile Equipment Identity number (“IMEI”). The PED would transmit the IMEI to the controller 44 over the user communications channel 126, and this IMEI would serve as a unique identifier of the user. Alternatively, the user device 128 could be a dedicated transmitter as described above programmed to transmit a unique identifier. Alternatively, the user device 128 could be a physical key or dongle equipped with a coded resistor or circuit which would be physically connected to a receptacle (not shown) of the controller 44.

As another example, the controller 44 could be equipped with or connected to a biometric sensor (not shown) operable to recognize one or more identifying features of a user. Known examples of such sensors include fingerprint sensors, weight sensors, iris or retinal scanners, and facial recognition devices.

Two or more of the identification methods described above may be combined to enhance the functionality or certainty of the identification. For example, a biometric identification such as weight may be required in addition to a manually-entered code or IMEI-based code. As an example, this could be used to prevent a child from using an adult's PED to gain unauthorized access to an outdoor power machine 42, because the child's weight would be significantly different from the adult's weight. As another example, a manual or remotely-entered code could be required in addition to the presence of an IMEI-based code.

Once the user has been identified, the controller 44 refers to a stored listing of users and the users' privileges and preferences. Each user may have an associated set of privileges for functions of the outdoor power machine 42. Additionally or in the alternative, each user may have an associated set of preferences with respect to customizable outdoor power machine functions. For example, the user list may be stored in one or more tables in the memory of the controller 44. Table 1 below illustrates a small sample of a table associating users with their operating privileges. In Table 1, “User ID” is the user's unique identification, “User Type” is a category of user, “MIR” refers to the ability to mow-in-reverse, that is, to move the outdoor power machine 42 backwards while the blade or blades are spinning, “Dual ID” refers to a requirement that a second user be connected to the controller for the outdoor power machine 42 to operate, “Date restrictions” refers to operating privileges defined by date, and “Ground speed limit” refers to a maximum ground speed permitted. These are just a few examples of numerous possible privileges that may be defined. In Table 1, it can be seen that the owner user ID 1000, may operate the outdoor power machine 42 without restriction, but the neighbor, user ID 1020, may only operate the outdoor power machine 42 during weekdays.

TABLE 1

| User | User | MIR | Dual ID | Date | Ground |
|---|---|---|---|---|---|
| ID | Type | permitted? | required? | restrictions | speed limit |
| 1000 | owner | Y | N | none | none |
| 1010 | child | N | Y | none | 30% of maximum |
| 1020 | neighbor | Y | N | weekdays | none |
| | | | | only | |

Some further examples of operating privileges will now be set forth. As one example, the controller 44 may provide full access to all outdoor power machine functions based solely on the user's identity. For example, once the user is identified, the controller may simply confirm that the user is in fact an authorized user and enable all outdoor power machine functions. This privilege level would typically be used for an owner/administrator. The controller 44 may also be provided with a “dealer mode” or super-administrator mode which is effective to override all limits and allow for troubleshooting, repair, and maintenance.

As another example, a user may be limited to using outdoor power machine functions only at certain times of day, on certain days of the week, or on certain dates. The controller 44 could determine the time and/or date by reference to an internal clock, or by external reference. For example, the controller 44 could be programmed to query a publicly-available Internet website containing published date and time information via the data communications channel 118.

As another example, a user may be limited to using outdoor power machine functions only during specified weather conditions. The controller 44 would determine the existing weather conditions by external reference. For example, the controller 44 could be programmed to query a publicly-available Internet website containing published real-time weather information, via the data communications channel 118.

As another example, a user may be limited to outdoor power machine functions only in specific terrain conditions, such as an incline below a specified limit. The controller 44 would determine incline using an inclinometer or accelerometer of a known type (not shown).

As another example, a user may be limited to using only specific attachments (e.g. mower deck, ground-engaging attachments). For example, use of the PTO 60 or mowing deck 64 could be locked out.

As another example, a user may be limited to a specific distance from the outdoor power machine's “home base”. The controller 44 could determine the location of the outdoor power machine 42 using the positioning device 132.

As another example, a user may be limited to a specific geographic location or coordinate-bounded area (e.g. “geo-fencing”). The controller 44 could determine the location of the outdoor power machine 42 using the positioning device 132.

As another example, the controller 44 may include a supervisory function. This feature could be used for a two-user relationship with a senior and junior user, such as parent/child, instructor/student, or employee/employer. When the junior user is identified, the controller 44 could send a notification to a senior user, for example by sending an alert to the user device 128 through the user communications channel 126. Once the senior user is connected, he or she would have the ability to send override commands and/or an emergency stop signal to the controller 44. The controller 44 could also be configured to permit operation only when the senior user is in close proximity to the outdoor power machine 42.

The controller 44 may permit full, limited, or no access to any combination of functions based on the user's stored privileges. Nonlimiting examples of outdoor power machine functions to be controlled include: prime mover run/stop/speed, blade or attachment run/stop/speed, ground speed run/stop/speed, and mow-in-reverse permit/lockout.

As noted above, each user may have an associated set of preferences with respect to customizable outdoor power machine functions. The controller 44 would automatically activate or operate the desired function upon identification. Table 2 below illustrates a small sample of a table associating users with their preferences. In Table 2, “User ID” is the user's unique identification, “User Type” is a category of user, “seat position” refers a fore-aft or up-down position of the operator seat 26, “seat heat” refers the on/off state of the seat heater 78, and “deck height” refers to the height of the mowing deck 64. In Table 1, it can be seen that the owner user ID 1000, prefers the seat in the 100% of range position, with the seat heater 78 turned on, and the deck height set at 3.5 inches, but the neighbor, user ID 1020, prefers the seat in the 95% of range position, with the seat heater 78 turned off, and the deck height set at 3.0 inches.

TABLE 2

| User | User | seat | seat | deck |
|---|---|---|---|---|
| ID | Type | position | heat? | height |
| 1000 | owner | 100% | Y | 3.5 inches |
| 1010 | child | 25% | N | 3.5 inches |
| 1020 | neighbor | 95% | N | 3.0 inches |

Some further examples of operating preferences include: deck height, seat position, pedal position, steering wheel position, display layout, audio/visual display preference, mirror position and heated seat/control settings.

Optionally, users other than the owner/administrator may have access to a reduced-functionality version of the remote control app 172, permitting each user to change his or her individual settings which are deemed preferences by the owner/administrator, but not to change his or her privileges. It is also noted that the status of a given outdoor power machine function as a “privilege” or a “preference” is not inherent, but can change depending on the owner/administrator's wishes. For example, the deck height may be set at a particular level by an owner or more senior user merely for convenience, i.e. as a preference, but a junior user may be assigned a single deck height which cannot be changed, i.e. as a privilege.

The operation of the controller 44 will now be described in the context of some procedural examples.

### EXAMPLE 1

### Operation by Friend or Neighbor of Owner

Initially, the owner would program the controller 44 (via the user interface 142) with a user identification (e.g. International Mobile Equipment Identity “IMEI” number and optionally a code, and the settings for the desired privileges and preferences of the user. The settings could be set manually or by using a pre-programmed set of privileges and preferences based on the category of user (e.g. “neighbor”).

Subsequently, the user would approach the outdoor power machine 42 and be identified. For example, when the user identification is based on IMEI number, the controller 44 could recognize pairing with the specific IMEI number of a PED of the user, optionally coupled with the code transmitted to the controller 44 by the user's PED.

Upon identification, the controller 44 would provide access to the privileged functions. For example, the user could be permitted to start the engine, start the blade, and drive the outdoor power machine 42 in any direction. The user could be blocked from mowing in reverse. The neighbor could be permitted to operate the outdoor power machine 42 only on weekdays from 9 am to 5 pm.

Additionally, the controller would activate any preferences, for example adjusting the seat to the neighbor's preferred position. Optionally, the user would be able to program any of the preference features.

The controller 44 would block or deactivate any outdoor power machine functions whenever the present limits are exceeded. For example, the mower would shut off or not start outside the defined time/day schedule.

### EXAMPLE 2

### Operation by a Child

Initially, the owner would program the controller 44 with a user identification (e.g. International Mobile Equipment Identity “IMEI” number and optionally a code, and the settings for the desired privileges and preferences. The settings could be set manually or by using a preset category (e.g. “child”).

Subsequently, the user would approach the outdoor power machine 42 and be identified. For example, the controller 44 would recognize pairing with a specific IMEI number, optionally coupled with the code.

Upon identification, the controller 44 may perform enhanced identification functions, such as (a) preventing operation until the owner is in proximity to the outdoor power machine 42 or (b) sending a message to the owner and requesting verification. The owner would then need to send a verification or permission signal from his or her user device 128.

The controller would provide access to the privileged functions. For example, the child user would be permitted to start the engine, start the blade, and drive the outdoor power machine 42 in any direction. The child would be blocked from mowing in reverse.

Additionally, the controller 44 would activate any preferences, for example adjusting the operator seat 64 to the child's preferred position.

The controller 44 would block or deactivate any outdoor power machine functions whenever the present limits are exceeded. For example, the outdoor power machine 42 would shut off or not start outside the defined time/day schedule. The owner would be able to remotely stop the outdoor power machine 42 at any time by sending a remote stop signal from his or her user device 128.

The foregoing has described an outdoor power machine, a controller apparatus, and a method for its operation. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

1. An outdoor power machine apparatus, comprising:
an outdoor power machine including a prime mover, the outdoor power machine operable to carry out at least one machine function;
an electronic controller operably connected to the at least one machine function and configured to identify a specific user and to control the at least one machine function based on the identity of the user; and
wherein one of the at least one machine functions is a material handling implement driven by the prime mover, and the controller is operable to permit, deny, or limit operation of the material handling implement based on the user's identity.

2. (canceled)

3. The apparatus of claim 1 wherein the controller is configured to operate at least one machine function in a desired manner based on the user's identity.

4. (canceled)

5. The apparatus of claim 1 wherein one of the at least one machine functions is an adjustable machine component moveable between different positions, and the controller is operable to move the adjustable component to a specified position based on the user's identity.

6. The apparatus of claim 1 wherein the controller is configured to identify a user in response to a code provided by the user.

7. The apparatus of claim 1 wherein the controller is configured to identify a user in response to a data transmission from a user device.

8. The apparatus of claim 1 wherein the controller is configured to identify a user in response to a predefined combination of two or more identification methods.

9. The apparatus of claim 1 wherein the controller includes a positioning device operable to determine a location of the outdoor power machine.

10. The apparatus of claim 1 wherein the controller includes a data communications channel operable for two-way communication with an external data source.

11. The apparatus of claim 1 wherein the controller includes a user communications channel operable for two-way communication with a user device.

12. The apparatus of claim 1 wherein the controller includes stored data relating each unique user to a set of privileges and preferences with respect to machine functions.

13. The apparatus of claim 1 wherein the controller includes a physical user interface including at least one display element and at least one input control.

14. An outdoor power machine control system, comprising:
an outdoor power machine including a prime mover, the outdoor power machine operable to carry out at least one machine function;
an electronic controller operably connected to the at least one machine function and operable to identify a specific user and control the at least one machine function based on the identity of the user;
a user device having a processor and presenting a remote user interface to the controller;
a user communications channel providing data communications between the controller and the user device; and
wherein one of the at least one machine functions is a material handling implement driven by the prime mover, and the controller is operable to permit, deny, or limit operation of the material handling implement based on the user's identity.

15. The system of claim 14 wherein the remote user interface comprises a software application.

16. The system of claim 14 wherein:
the controller includes a physical user interface including at least one display element and at least one input control; and
the remote user interface is a reproduction of at least part of the physical user interface.

17. The system of claim 14 wherein the remote user interface is operable to send override commands to the controller.

18. The system of claim 14 wherein the controller is configured to identify a user in response to a code provided by the user through the remote interface.

19. The system of claim 14 wherein the controller is configured to identify a user in response to a data transmission from the user device.

20. (canceled)

21. The system of claim 14 wherein the controller includes a data communications channel operable for two-way communication with an external data source separate from the user device.

22. The system of claim 14 wherein the controller includes stored data relating each unique user to a set of privileges and preferences with respect to machine functions, and the remote interface is operable to edit the stored data.

23-31. (canceled)

32. The apparatus of claim 1, wherein the outdoor power machine is a lawn mower, and wherein the material handling implement is a cutting blade of the lawn mower.
